(19) United States
(12) Patent Application Publication
(10) Pub. No.: US 2007/0103078 A1
(43) Pub. Date: May 10, 2007

(54) Plasma display panel

(76) Inventors: Seung-Hyun Son, Suwon-si (KR); Sang-Hun Jang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/593,581

(22) Filed: Nov. 7, 2006

(30) Foreign Application Priority Data
Nov. 8, 2005 (KR) 10-2005-0106391

(51) Int. Cl. H01J 1/62; H01J 17/49

(52) U.S. Cl. 313/587; 313/582; 313/583; 313/498; 313/501; 313/500

(57) ABSTRACT

A plasma display panel may include a first substrate, a second substrate opposing the front substrate, a plurality of discharge cells defined between the first substrate and the second substrate, a plurality of sustain discharge electrode pairs formed on the first substrate, a dielectric layer covering the sustain discharge electrode pairs, electroluminescent (EL) layers formed on the dielectric layer at least partially overlapping the discharge cells, a discharge gas disposed in the discharge cells; and phosphor layers formed in the discharge cells.

### BACKGROUND OF THE INVENTION

1. Field of the Invention

The invention relates to plasma display panels (PDP). More particularly, to a PDP including phosphor layers and EL layers, and having improved brightness and luminance distribution.

2. Description of the Related Art

In plasma display panels (PDP), brightness and luminous efficiency are main factors which determine the performance of a PDP. In order to improve luminous efficiency and brightness of the PDP, a surface area of a phosphor layer can be increased. However, there is a limitation in increasing the surface area of the phosphor layer due to a structure of the PDP.

In addition, in order to improve brightness of the PDP, a discharge voltage applied to electrodes can be increased. However, when the discharge voltage is higher than a predetermined voltage, brightness may not be further improved and/or a ratio corresponding to the increasing brightness is reduced, whereby luminous efficiency of the PDP is lowered.

PDPs having pixels of 640×480 and 800×600 have been used. However, as PDPs having pixels of 1940×1035 are being developed, a more need for improving brightness and luminous efficiency of the PDP is required. That is, as the PDP has been made to display high definition images, the size of discharge cells of the PDP is being reduced and a surface area of a phosphor layer applied in the discharge cells is also reduced. As the surface area of the phosphor layer is reduced, the amount of visible light emitted from the phosphor layer is reduced, brightness of the PDP is lowered, whereby luminous efficiency of the PDP is lowered.

### SUMMARY OF THE INVENTION

The invention is therefore directed to a plasma display panel, which substantially overcomes one or more of the problems due to the limitations and disadvantages of the related art.

It is therefore a feature of embodiments of the invention to provide a plasma display panel (PDP) having improved brightness relative to conventional PDPs.

It is therefore a separate feature of embodiments of the invention to provide a PDP having improved luminous efficiency without requiring a discharge voltage to be increased.

At least one of the above and other features and advantages of the invention may be realized by providing a plasma display panel including a first substrate, a second substrate opposing the first substrate, a plurality of discharge cells defined between the first substrate and the second substrate, a plurality of sustain discharge electrode pairs formed on the first substrate, a dielectric layer covering the sustain discharge electrode pairs electroluminescent (EL) layers formed on the dielectric layer at least partially within the discharge cells, a discharge gas disposed in the discharge cells, and phosphor layers formed in the discharge cells.

The EL layers may include at least one of inorganic EL material and quantum dots. The EL layers may emit light when a sustain voltage is applied between electrodes that form the sustain discharge electrode pairs. The EL layers may include ZnS:Mn, ZnS:Tb, SrS:Ce, Ca₂S₄:Ce, SrS:Cu, SrS:Ag, CaS:Pb, and/or BaAl₂:Eu. A thickness of the EL layers may be about 500 Å to about 5000 Å. The quantum dots may include a core formed of CdSe, a shell formed of ZnS and surrounding the core, and caps formed of trioctylphosphine oxide (TOPO) and disposed outside the shell.

The EL layers may at least partially overlap with the sustain discharge electrodes. The EL layers may include a transparent material. Each of the discharge cells may include at least one of the EL layers arranged therein. The EL layers may correspond to each of the electrodes that form the sustain discharge electrode pairs and two EL layers may be disposed in each of the discharge cells. Respective portions of the two EL layers associated with each of the discharge cells may be substantially symmetrically arranged within the respective discharge cell. Each of the discharge cells may include two of the EL layers arranged therein, wherein each of the EL layers may only be within one of the of the discharge cells, wherein the EL layers may completely overlap with respective portions of the sustain discharge electrode pair of the respective discharge cell.

The plasma display panel may include address electrodes extending on the second substrate to cross the sustain discharge electrode pairs, and a second dielectric layer covering the address electrodes.

The first substrate may correspond to a front substrate of the plasma display panel, the EL layers may be arranged on the front substrate, and the EL layers may be formed of a transparent material. The first substrate may correspond to a rear substrate of the plasma display panel, the EL layers may be arranged on the rear substrate.

At least one of the above and other features and advantages of the invention may be separately realized by providing a display panel, including a first substrate, a second substrate, a plurality of discharge cells defined between the first substrate and the second substrate, a plurality of sustain discharge electrode pairs arranged on one of the first substrate and the second substrate, a dielectric layer covering the plurality of sustain discharge electrode pairs, first light emitting elements for emitting light toward the first substrate, and second light emitting elements for emitting light toward the first substrate, wherein for each of the discharge cells the second light emitting elements are arranged along a sustain discharge path of the plurality of sustain discharge electrode pairs, and the first light emitting elements and the second light emitting elements substantially simultaneously emit light toward the first substrate based on a voltage potential across a corresponding one of the plurality of sustain discharge electrode pairs.

The first light emitting elements may include a discharge gas and at least one phosphor layer, and the second light emitting elements may include an electroluminescent layer.

### BRIEF DESCRIPTION OF THE DRAWINGS

The above and other features and advantages of the invention will become more apparent to those of ordinary skill in the art by describing in detail exemplary embodiments thereof with reference to the attached drawings in which:

FIG. 1 illustrates an exploded perspective view of a plasma display panel (PDP) according to an exemplary embodiment of the invention;

FIG. 2 illustrates a cross-sectional view of the plasma display panel illustrated in FIG. 1, taken along line 11-II of FIG. 1;

FIGS. 3A and 3B illustrate cross-sectional views of a portion of a discharge cell of the PDP illustrated in FIG. 1 including a general charge distribution pattern according to respective charged states of sustain discharge electrode pairs;

FIG. 4 illustrates a plan view of electrodes and an EL layer of the PDP illustrated in FIG. 1;

FIG. 5 illustrates a cross-sectional diagram of an exemplary quantum dot as an exemplary element for the EL layer of the PDP illustrated in FIG. 1;

FIG. 6 illustrates an exploded perspective view of a PDP according to a second exemplary embodiment of the invention; and

FIG. 7 illustrates a cross-sectional view of the exemplary PDP illustrated in FIG. 6, taken along line VII-VII of FIG. 6.

### DETAILED DESCRIPTION OF THE INVENTION

Korean Patent Application No. 10-2005-0106391, filed on Nov. 8, 2005, in the Korean Intellectual Property Office, and entitled: “Plasma Display Panel,” is incorporated by reference herein in its entirety.

The invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” or “sandwiched between” two layers, it can be the only layer between the two layers, or one or more intervening layers may also be present. Like reference numerals refer to like elements throughout.

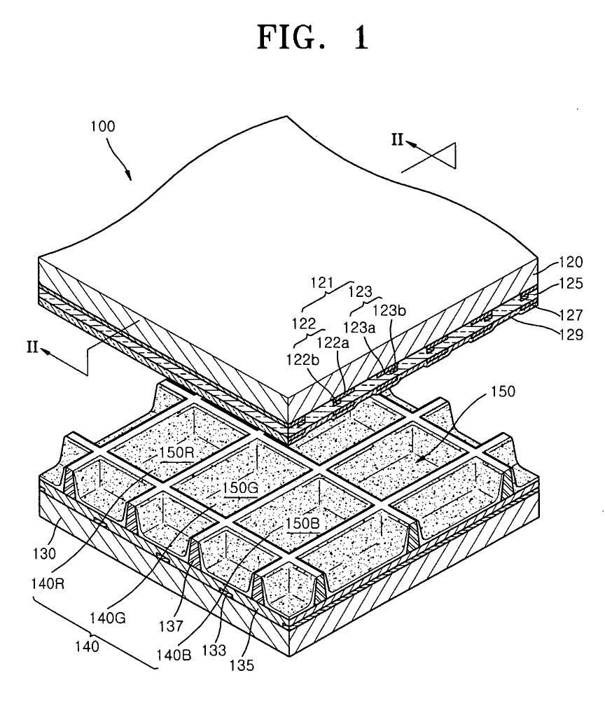

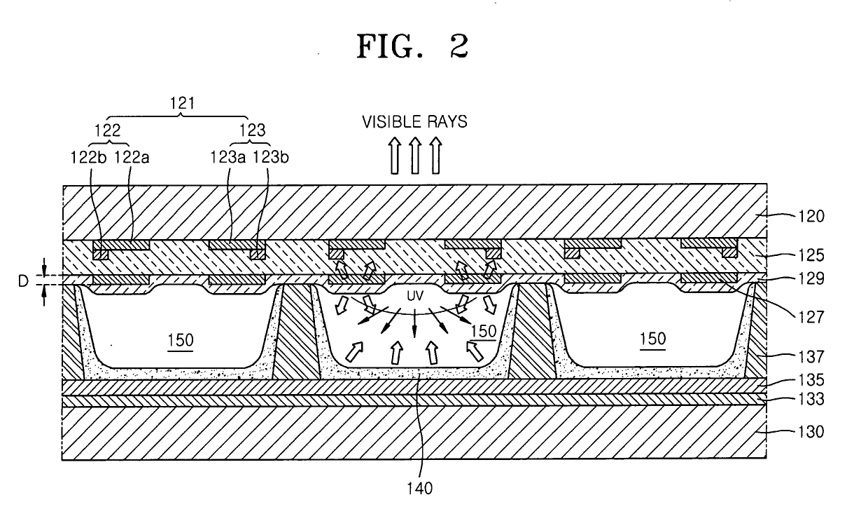

FIG. 1 illustrates an exploded perspective view of a plasma display panel (PDP) 100 according to an exemplary embodiment of the invention, and FIG. 2 illustrates a cross-sectional view of the PDP 100 illustrated in FIG. 1, taken along line II-II of FIG. 1. Referring to FIGS. 1 and 2, the PDP 100 may include a front substrate 120, a rear substrate 130, a plurality of barrier ribs 137, a plurality of sustain discharge electrode pairs 121, a plurality of electroluminescent (EL) layers 127, a discharge gas (not shown), and a plurality of phosphor layers 140. The rear substrate 130 and the front substrate 120 may be arranged parallel to each other, may be separated from each other by a predetermined gap and sides thereof may be sealed for containing the discharge gas (not shown) therebetween.

In general, display devices transmit visible light toward the front substrate 120 to display images thereon. In embodiments of the invention, at least some visible light may be transmitted toward the rear substrate 130 to display images on the PDP 100. The PDP 100 may be, e.g., a reflective-type, a transmissive-type or a transreflective-type.

At least one barrier rib 137 may be formed between the front substrate 120 and the rear substrate 130. The barrier ribs 137 may be disposed on and/or correspond to a non-discharge portion of the PDP 100. Together with the front substrate 120 and the rear substrate 130, the barrier ribs 137 may at least partially define discharge cells 150. The barrier ribs 137 may prevent cross-talk of charged particles amongst, e.g., adjacent discharge cells 150. In embodiments of the invention, the barrier ribs 137 may be formed on a front surface of a rear dielectric layer 135.

Each of the discharge cells 150 may constitute one unit pixel of the PDP 100, and may include a group of different colored discharge cells. For example, in embodiments of the invention, the discharge cell 150 may include red discharge cells 150R, blue discharge cells 150B and green discharge cells 150G.

The phosphor layers 140 may be arranged in the discharge cells 150. More particularly, e.g., the red discharge cell 150R may include a red phosphor layer 140R, the blue discharge cell 150B may include a blue phosphor layer 140B, and the green discharge cell 150G may include a green phosphor layer 140G. The phosphor layers 140 may be disposed on side surfaces of the barrier ribs 137 and/or on the front surface of the rear dielectric layer 135 between, e.g., adjacent ones of the barrier ribs 137.

At least portions of the sustain discharge electrode pairs 121 and address electrodes 133 may overlap the discharge cells 150. The sustain discharge electrode pairs 121 include X electrodes 122 and Y electrodes 123, or respective portions thereof, associated with each of discharge cell may cause a sustain discharge. In embodiments of the invention, the X electrodes 122 and the Y electrodes 123 may include transparent electrodes 122a and123a and bus electrodes 122b and 123b, respectively. The X electrodes 122 and the Y electrodes 123 may extend parallel to each other on, e.g., a rear surface of the front substrate 120. A front dielectric layer 125 may cover the X electrodes 122 and the Y electrodes 123 and/or exposed portions of the front substrate 120.

Each of the sustain discharge electrode pairs 121 may be associated with one of the address electrodes 133. The address electrodes 133 may be arranged on, e.g., a front surface of the rear substrate 130. The address electrodes 133 may extend parallel to each other and along a direction that crosses a direction along which the sustain discharge electrode pairs 121 extend. In embodiments of the invention, the address electrodes 133 may extend substantially perpendicular to the sustain discharge electrode pairs 121. The address electrodes 133 and/or exposed portions of the rear substrate 130 may be covered by the rear dielectric layer 135.

The EL layers 127 may be formed on a rear surface of the front dielectric layer 125. The EL layers 127 and exposed portions of the rear surface of the front dielectric layer 125, e.g. portions of the rear surface of the front dielectric layer 125 where the EL layers 127 are not formed, may be covered with a protective layer 129. While the protective layer 129 is not an essential element, the protective layer 129 may prevent charged particles from colliding with the EL layers 127 and the front dielectric layer. The protective layer 129 may also emit a relatively large amount of secondary electrons during a discharge operation, and may enable a sustain discharge voltage to be reduced.

The EL layers 127 may overlap with respective portions of the sustain discharge electrode pairs 121. For example, the EL layers 127 may overlap with respective portions of the X electrodes 122 and the Y electrodes 123. More particularly, e.g., the EL layers 127 may overlap with respective portions of the transparent electrodes 122a and123a and/or the bus electrodes 122b and 123b. That is, in embodiments of the invention, the EL layers 127 may partially, substantially and/or completely overlap with at least portions of the sustain discharge electrode pairs 121, and may be sandwiched between the sustain discharge electrode pairs 121 and portions of the address electrodes 133 and/or portions of the rear substrate between adjacent ones of the barrier ribs 137. That is, the EL layers 127 may be formed along a sustain discharge path between the sustain discharge electrode pairs 121.

Further, in embodiments of the invention, one, some, or all of the discharge cells 150 may include and/or be associated with one or more EL layers 127. Thus, in embodiments of the invention, some of the discharge cells 150 may not include and/or be associated with any of the EL layers 127.

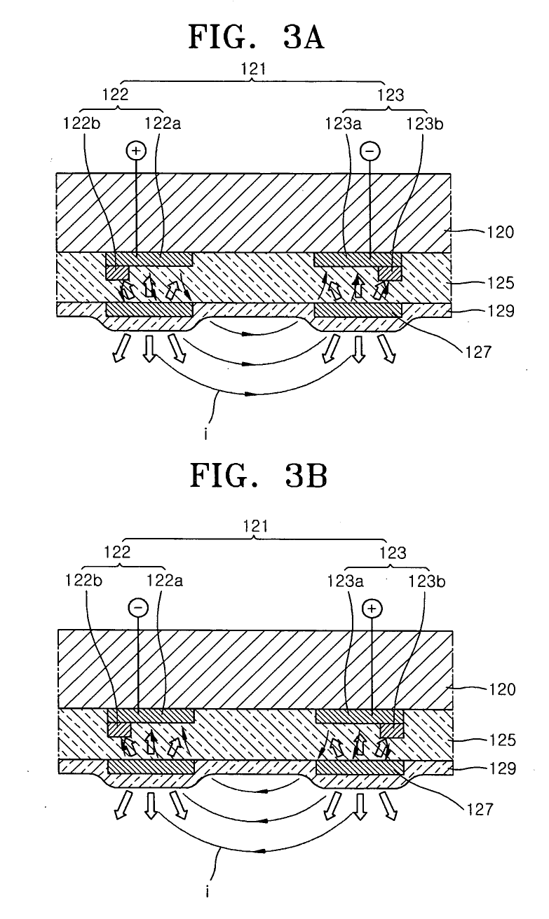

FIGS. 3A and 3B illustrate cross-sectional views of a portion of a discharge cell of the PDP 100 illustrated in FIG. 1, including a general charge distribution pattern according to respective charged states of the sustain discharge electrode pairs 121. As illustrated in FIGS. 3A and 3B, the EL layers 127 may be arranged along the sustain discharge path between the X electrodes 122 and the Y electrodes 123. As a result, when, e.g., the X electrodes 122 and the Y electrodes 123 are charged, electrons may pass through the EL layers 127, thereby producing light. That is, when a sustain discharge between the X electrodes 122 and the Y electrodes 123 occurs in respective ones of the discharge cells 150 to be turned on, charges may move along the sustain discharge path in a discharge space of the discharge cell(s). The discharge space in the discharge cells 150 in which the X electrodes 122 and the Y electrodes 123 are disposed may have an electrically low resistance during a sustain period. Accordingly, a current i may flow along the sustain discharge path.

Referring to FIGS. 3A and 3B, polarities of the X electrodes 122 and the Y electrodes 123 may be alternately changed during the sustain period(s). FIG. 3A illustrates a charged stated where a high voltage is applied to the X electrode 122 and a low voltage is applied to the Y electrode 123. FIG. 3B illustrates another charged state where the low voltage is applied to the X electrode 122 and the high voltage is applied to the Y electrode 123. As illustrated in FIGS. 3A and 3B, charges may move along the sustain discharge path from the X electrodes 122 to the Y electrodes 123 or from the Y electrodes 123 to the X electrodes 122, and may collide with the discharge gas in the respective discharge cell 150. When the charges collide with the discharge gas, UV light may be emitted. The emitted UV light may collide with the phosphor layers 140, and visible light may be produced from the phosphor layers 140.

As discussed above, in embodiments of the invention, EL layers 127 may be arranged along the sustain discharge path of the X and Y electrodes 122, 123, and thus, in the respective discharge cell(s) 150 to be turned on, the current i may pass through the EL layers 127, wherein electrons may move in a direction opposite to a direction of flow of the current i. Thus, electron transfer or tunneling may occur in the EL layers 127, and light may be produced. Thus, in embodiments of the invention, light produced from the EL layers 127 and the visible light emitted from the phosphor layers 140 may be emitted through the front substrate 120, and, thus, brightness and luminous efficiency of the PDP 100 may be improved. That is, in embodiments of the invention, brightness and luminous efficiency of the PDP 100 may be improved by providing multiple sources of light emission, e.g., phosphor layers 140 and EL layers 127.

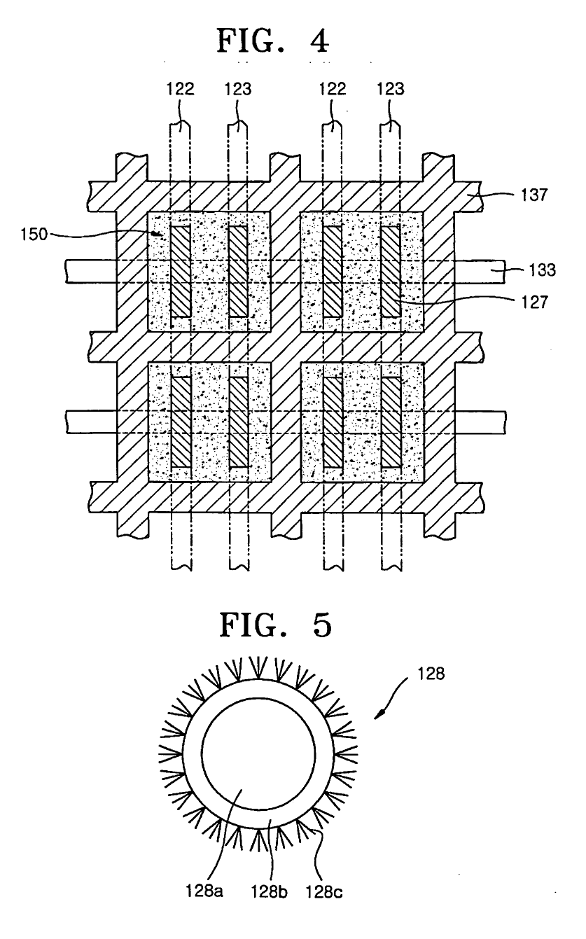

FIG. 4 illustrates a plan view of electrodes and an EL layer of the PDP illustrated in FIG. 1. As illustrated in FIG. 4, in embodiments of the invention, two of the EL layers 127 may be arranged in one, some or all of the discharge cells 150. The EL layers 127 may extend along a same direction as the direction along which the sustain discharge electrode pairs 121 extend. Although the exemplary embodiment illustrated in FIG. 4, illustrates two of the EL layers 127 in each discharge cell 150, embodiments of the invention are not limited to two EL layers 127 for each of the discharge cells 150, and the discharge cells 150 may include one or more than two EL layers.

In embodiments of the invention by providing independent EL layers 127 in the discharge cells 150, the possibility of light being produced from portions of the EL layers 127 overlapping the barrier ribs 137 and/or cross-talk among adjacent ones of the discharge cells 150 may be reduced and/or minimized.

In other exemplary embodiments of the invention, e.g., the EL layers 127 may correspond to each of the X electrodes 122 and the Y electrodes 123, extending along multiple discharge cells 150. Manufacture of such EL layers 127 may be advantageous, e.g., simpler. In such embodiments, cross-talk among adjacent ones of the discharge cells 150 may be higher relative to embodiments with independent EL layers 127 in the discharge cells 150.

The sustain discharge path of the sustain discharge electrode pairs 121 may generally correspond to an upper portion of the discharge cell 150 associated with the respective one of the sustain discharge electrode pairs 121. Thus, the EL layer(s) 127 may be arranged substantially anywhere in the respective discharge cell 150 between, e.g., the sustain discharge electrode pair 121 and the phosphor layer 140. For example, the EL layer(s) 127 may be arranged on portions of the front dielectric layer 125 exposed to the respective discharge cell 150. That is, as illustrated in FIG. 2, the EL layers 127 may also be arranged along a path of the visible light produced from the phosphor layers 140 in the discharge cells 150.

More particularly, in embodiments of the invention, the EL layers 127 may be symmetrically or substantially symmetrically arranged in each of the discharge cells 150. For example, in embodiments including two of the EL layers 127, i.e., independent layers or portions of continuous layers, each of the discharge cells 150, one of the EL layers 127 symmetrically arranged on each side of the discharge cells 150. Thus, light from the EL layers 127 may be emitted from both sides of the discharge cell 150. That is, by symmetrically arranging the EL layer(s) 127 in the discharge cells, it may be possible for the discharge cells 150 to emit substantially uniformly distributed light.

A general description of exemplary materials that may be employed for different layers or elements of the PDP 100 is provided below. Referring to FIGS. 1 and 2, the discharge gas (not shown) may be filled in the discharge cells 150. A penning mixture such as, e.g., Xe—Ne, Xe—He, or Xe—Ne—He may be used as the discharge gas. Xe may be used as a main discharge gas because, e.g., Xe is a chemically stable inert gas, generally does not dissociate by a discharge, has a relatively high atomic number, may enable an excitation voltage to be reduced, and a wavelength of emitted light may be relatively long. He and/or Ne may generally be used as a buffer gas because a voltage reduction effect caused by penning due to Xe and a sputtering effect caused by high pressure may be reduced. The main discharge gas may include, e.g., a rare gas such as Kr.

The front substrate 120 and the rear substrate 130 may include a material having excellent light transmission characteristics, such as glass.

The phosphor layers 140 may be classified into red phosphor layers 140R, green phosphor layers 140G, and blue phosphor layers 140B, according to colors of visible light. The red phosphor layers 14OR may include phosphor such as, e.g., Y(V,P)O₄:Eu, the green phosphor layers 140G include phosphor such as, e.g., Zn₂SiO₄:Mn, and the blue phosphor layers 140B include phosphor such as, e.g., BAM:Eu.

The red discharge cells 150R in which the red phosphor layers 140R are disposed may serve as red subpixels, the green discharge cells 150G in which the green phosphor layers 140G are disposed may serve as green subpixels, and the blue discharge cells 150B in which the blue phosphor layers 140B are disposed may serve as blue subpixels. As discussed above, the red subpixels, the green subpixels, and the blue subpixels may form one unit pixel, thereby representing a wide range of colors according to various combinations of the primary R, G, B colors.

The EL layers 127 may include an inorganic EL material. The inorganic EL material may be a light transmissive material, which may, e.g., transmit visible light. When voltages having different polarities are applied to two sides of the inorganic EL material, electron transfer may occur in the inorganic EL material, and light may be produced. Thus, if voltages are applied between the sustain discharge electrode pairs 121, light may be produced in the EL layers 127, which may include, e.g., inorganic EL material. As discussed above, the light emitted from the EL layers 127 may be combined with visible light produced from the phosphor layers 140, and emitted so that brightness and luminous efficiency of the PDP 100 may be improved. A more detailed description of exemplary material(s) that may be employed for the EL layers 127 is provided below.

A general description of an exemplary operation of the PDP 100 is provided below. To drive the PDP 100, an address discharge and a sustain discharge may be initiated in the discharge cells 150. To initiate an address discharge, an address voltage may be applied between the address electrodes 133 and the Y electrodes 123. More particularly, the address voltage may be applied between respective ones of the address electrodes 133 and the Y electrodes 123 associated with discharge cells 150 that are to be turned on during a subsequent sustain discharge operation. As a result of the address discharge, the discharge cell(s) 150 in which a sustain discharge is to occur during the subsequent sustain discharge operation, may be selected. Then, to initiate a sustain discharge operation between the X electrodes 122 and the Y electrodes 123, an AC sustain discharge voltage may be applied between the X electrodes 122 and the Y electrodes 123 of the selected discharge cells 150. As a result, an energy level of a discharge gas excited by the sustain discharge may be reduced and UV light may be emitted. The UV light may excite the phosphor layers 140 in the discharge cells 150. The energy level of the excited phosphor layers 140 may be reduced, visible light may be emitted, and the emitted visible light may enable an image(s) to be realized on the PDP 100.

In embodiments of the invention, the sustain discharge voltage may be about 150V to about 180 V, and the sustain discharge voltage may be alternately applied between the X electrodes 122 and the Y electrodes 123 during a sustain period of a frame. In the discharge space in the discharge cells 150 selected during the prior addressing period, charges having signs opposite to signs of the applied sustain discharge voltage may move in the discharge space of the selected discharge cells 150 and on and/or toward the rear dielectric layer 135, corresponding to the X electrodes 122 and the Y electrodes 123. Accordingly, when the sustain discharge voltage is applied to the X electrodes 122 and the Y electrodes 123, current may flow from the X electrodes 122 to the Y electrodes 123 or from the Y electrodes 123 to the X electrodes 122 along the front dielectric layer 125 and the discharge space in the discharge cells 150.

Further, when sustain discharge occurs in the selected ones of the discharge cells 150, voltages having opposite polarities may be applied to front and rear surfaces of the EL layers 127. When sustain discharge occurs, current does not flow in the discharge cells 150 that were not selected during the prior addressing operation. Thus, in such non-selected ones of the discharge cells 150, light may not emitted from the EL layers 120 associated therewith.

As discussed above, the EL layers 127 may include inorganic EL material and may be arranged on the rear surface of the front dielectric layer 125, i.e., along the sustain discharge path of the sustain discharge electrodes 121. Thus, when the sustain discharge occurs in the selected discharge cells 150, UV, visible and/or infrared light may be emitted from the EL layers 127 of those selected discharge cells 150. Such UV light may collide with the phosphor layers 140 and generate additional visible light, i.e., visible light in addition to visible light generated by collision of UV light generated by the discharge gas (not shown) and the phosphor layers 140. The visible light emitted form the EL layers 127 together with the visible light emitted from the phosphor layers 140 may be transmitted to the front substrate 120 where an image(s) may be realized on the PDP 100. Thus, the light emitted from the inorganic EL layers 127 may be combined with the visible light produced from the phosphor layers 140, and the combined light may be emitted through the front substrate 120, thereby increasing an amount of light emitted from the discharge cells 150 and improving a brightness of the PDP 100.

Thus, in embodiments of the invention including the EL layers 127, e.g., a light emitting inorganic material, brightness and luminous efficiency of the PDP 100 may be improved without requiring any additional voltage beyond a minimum sustain discharge voltage applied between the X electrodes 122 and the Y electrodes 123 for initiating discharge of the discharge gas (not shown) in the selected ones of the discharge cells 150. Thus, when the sustain discharge voltage is about 150V to about 180 V for initiating discharge of the discharge gas (not shown) in the selected ones of the discharge cells 150, when a potential difference of about 150V to about 180 V exists between the inorganic EL layers 127 of 150-180 V occurs, the inorganic EL layers 127 may also emit light.

In embodiments of the invention, the EL layers 127 may include inorganic material including at least one of ZnS:Mn, ZnS:Tb, SrS:Ce, Ca₂S₄:Ce, SrS:Cu, SrS:Ag, CaS:Pb, and/or BaAl₂:Eu. For example, the EL layers 127 may include, e.g., ZnS:Mn, ZnS:Tb having a brightness of about 4000 cd/m² to about 5000 cd/m².

Referring to FIG. 2, a thickness D of the EL layers 127 may be about 500 Å to about 5000 Å. When the thickness D of the EL layers 127 is greater than about 5000 Å, light transmission may be lowered, and when the thickness D of the EL layers 127 is less than about 500 Å, a sufficient amount of light may not produced from the EL layers 127.

In embodiments of the invention, the EL layers 127 may include a plurality of quantum dots 128. FIG. 5 illustrates a cross-sectional diagram of an exemplary quantum dot 128, as an exemplary element, for the EL layers 127. Theoretically, quantum efficiency of the quantum dots 128 may be improved up to 100%, and electrons may be excited even at a low voltage, so that luminous efficiency may be improved. In embodiments of the invention, the EL layers 127 including such quantum dots 128 may be formed using, e.g., a printing process. This exemplary process of forming the EL layers 127 may be advantageous for making larger display apparatus.

As illustrated in FIG. 5, the quantum dots 128 may include a core 128a, a shell 128b surrounding the core 128a, and caps 128c disposed outside the shell 128b. The core 128a may be formed of, e.g., CdSe. The shell 128b may be formed of, e.g, ZnS. The caps 128c may be formed of, e.g., trioctylphosphine oxide (TOPO).

The EL layers 127 including the quantum dots 128 may be a single layer structure or a multi-layer structure. However, luminous efficiency of EL layers 127 having a single layer structure may be higher than the luminous efficiency of EL layers 127 having a multi-layer structure.

As discussed above, the EL layers 127 may be arranged along the path along which visible light travel from the phosphor layers 140 toward the front substrate 120, and thus, the EL layers 127 may include light transmissive material(s).

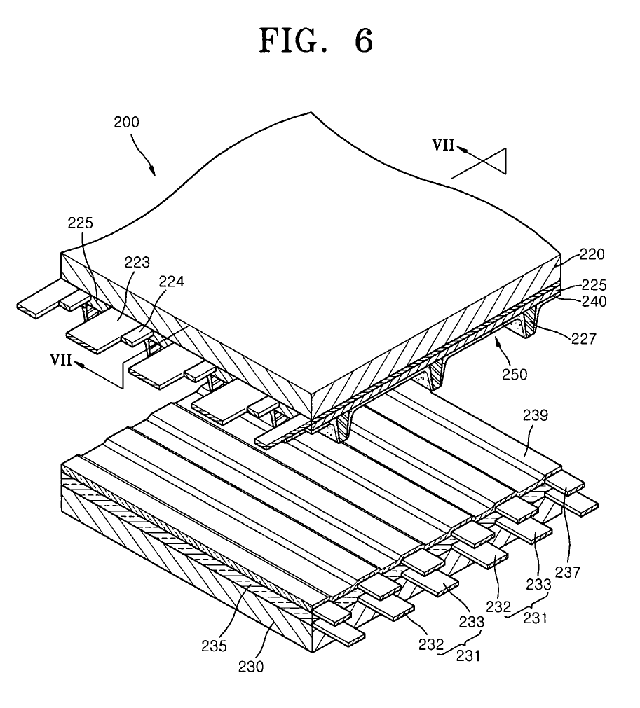

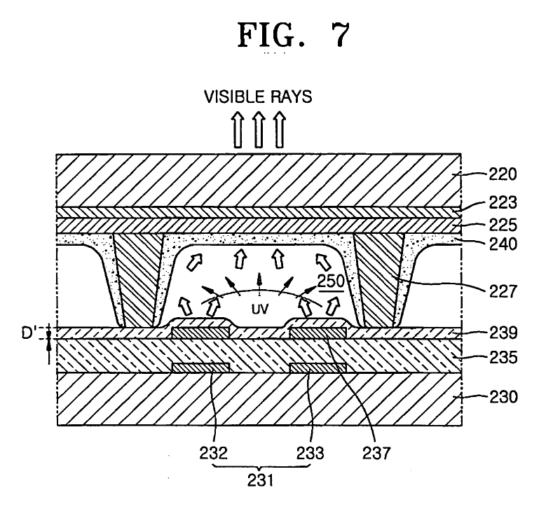

FIG. 6 illustrates an exploded perspective view of a PDP according to a second exemplary embodiment of the invention, and FIG. 7 illustrates a cross-sectional view of the exemplary PDP illustrated in FIG. 6, taken along line VII-VII of FIG. 6. In the following description of the exemplary PDP illustrated in FIGS. 6 and 7, to avoid repetition a detailed description of like features, having like reference numbers, among the illustrated exemplary embodiments will be avoided.

Referring to FIGS. 6 and 7, a second exemplary PDP 200 employing one or more aspects of the invention is illustrated. The PDP 200 may be a transmissive-type PDP. The PDP 200 may include a rear substrate 230 and a front substrate 220, which oppose each other. The rear substrate 230 and the front substrate 220 may be separated from each other by a predetermined gap and sides thereof may be sealed for containing a discharge gas (not shown) therebetween.

The rear substrate 230 may be, e.g., a glass substrate. A plurality of sustain discharge electrode pairs 231 may be formed on a front surface of the rear substrate 230. The sustain discharge electrode pairs may 221 may extend parallel to each other. The sustain discharge electrode pairs 231 may be disposed in such a manner that at least a portion of a pair of X electrodes 232 and Y electrodes 233 may be disposed in and/or associated with each discharge cell 250. A rear dielectric layer 235 may cover the sustain discharge electrode pairs 231 and exposed portions of the front surface of the rear substrate 230. The rear dielectric layer 235 may be formed by applying a dielectric material on the front surface of the rear substrate 230, and may have a thickness of about 15 μm to about 40 μm.

A plurality of EL layers 237 may be formed on the front surface of the rear dielectric layer 235. The EL layers 237 may be formed of a light emitting material that may emit light when a sustain discharge voltage is applied between the X electrodes 232 and the Y electrodes 233. As discussed above with regard to the EL layers 137 of the exemplary PDP 100, the EL layers 237 may be formed along a sustain discharge path between the X electrodes 232 and the Y electrodes 233. In embodiments of the invention, e.g., two independent EL layers 237 may be formed in each discharge cell 250 and may completely or partially overlap with the X electrodes 232 and the Y electrodes 233. As discussed above with regard to EL layers 137, embodiments of the invention are not limited to such a structure.

The EL layers 237 may be formed of an inorganic EL material. The inorganic EL material include at least one of, e.g., ZnS:Mn, ZnS:Tb, SrS:Ce, Ca₂S₄:Ce, SrS:Cu, SrS:Ag, CaS:Pb, and/or BaAl₂:Eu. In embodiments of the invention, the function and/or structure of the EL layers 237 is similar to the EL layers 137 described above, and thus, a detailed description thereof will be omitted. For example, the EL layers 237 may include the quantum dots 128.

In the exemplary embodiment of the PDP 200 illustrated in FIGS. 6 and 7, because visible light produced from phosphor layers 240 do not transmit through the EL layers 237, the EL layers 237 may include non-transparent materials and/or transparent materials. As a result of the arrangement of the EL layers on the rear substrate 230, a thickness D′ of the EL layers 237 may be greater than the thickness D of the EL layers 127 of the PDP 100 illustrated in FIG. 1. Thus, a manufacturing process for forming the EL layers 237 may be easier than a manufacturing process for forming the EL layers 137. In embodiments of the invention, the thickness D′ of the EL layers 237 may be several μm.

The EL layers 237 may be disposed along sustain discharge path between the rear dielectric layer 235 and the front substrate 220. The sustain discharge path of the sustain discharge electrode pairs 221 may generally correspond to a lower portion, i.e., portion closer to rear substrate 230, of the discharge cell 250 associated with the respective one of the sustain discharge electrode pairs 221. Thus, when voltages having different polarities are applied to two sides, e.g., upper and lower sides, of the EL layers 237 in discharge cells 250 to be turned on, electrons may be excited in the EL layers 237 and light may be emitted. In the discharge cells 250 to be turned or maintained off, wall charges are not generated in the discharge space and light is not emitted from EL layers 237 associated with the respective non-selected ones of the discharge cells 250.

A protective layer 239 may cover the EL layers 237 and exposed portions of a front surface of the rear dielectric layer 235 and/or the rear substrate 230. The protective layer 239 may prevent charged particles from colliding with and damaging the rear dielectric layer 235 and the sustain discharge electrode pairs 231 as a result of, e.g., sputtering of plasma particles, may emit secondary electrons and may reduce a discharge voltage and a sustain voltage. The protective layer 239 may be formed by applying magnesium oxide (MgO) on the front surface of the rear dielectric layer 235. The protective layer 239 may have a thickness of about 0.2-2 μm. In embodiments of the invention, the protective layer 239 may not be provided.

The front substrate 220 may be a transmissive substrate through which visible light may be transmitted to realize an image(s) on the PDP 200. The front substrate 200 may be formed of, e.g., a transparent glass. A plurality of address electrodes 223 may be formed on a bottom surface of the front substrate 220. The address electrodes 223 may extend along a direction crossing a direction along which the sustain discharge electrode pairs 231 extend. A front dielectric layer 225 may cover the address electrodes 223 and/or exposed portion(s) of the bottom surface of the front substrate 220.

At least one barrier rib 227 may be formed between the front substrate 220 and the rear substrate 230 at predetermined intervals. The barrier ribs 227 may partition the space between the front substrate 220 and the rear substrate 230. Together with the front substrate 220 and the rear substrate 230, the barrier rib(s) 227 may define the discharge cells 250, and may prevent electrical and optical interference amongst adjacent ones of the discharge cells 250.

The discharge gas such as Ne, Xe or a mixture thereof is filled in the discharge space. Phosphor layers 240 may be provided on a rear surface of the front dielectric layer 225 and/or side surfaces of the barrier ribs 227, to a predetermined thickness.

In the PDP 200 having the above structure, pairs of the X and Y electrodes 232 and 233 are disposed on the rear substrate 230, and a discharge may occur on a plane of the rear substrate 230. As such, visible light emitted from the phosphor layers 240 may transmit the phosphor layers 240 and the front substrate 220, and may be emitted from the front substrate 220.

In such PDPs, e.g. PDP 200, the rear dielectric layer 235 may be formed on the rear substrate 230, and may cover the sustain discharge electrode pairs 231 and/or exposed portions of the rear substrate 230. The rear dielectric layer 235 may be formed of a reflective, e.g., white dielectric material so that visible light emitted from the phosphor layers 240 in the discharge space can be reflected. The front dielectric layer 225 may be formed on the rear surface of the front substrate 220, and may cover the address electrodes 223 and/or exposed portion(s) of the front substrate 220. The front dielectric layer 225 may be formed of a transparent dielectric material so that visible light may transmit through to the front substrate 220.

The address electrodes 223 disposed on the rear surface of the front substrate 220 may be formed of a transparent conductive material, such as indium tin oxide (ITO), so that visible light may transmit the front substrate 220. In embodiments of the invention, the address electrodes 223 may be formed of ITO which is a transparent conductive material having a relatively high resistance. Thus, in order to reduce a line resistance, bus electrodes 224 formed of a metallic material having high conductivity may be coupled with the address electrodes 223, respectively.

The sustain discharge electrode pairs 231 disposed on the front surface of the rear substrate 230 may be formed of, e.g., transparent or non-transparent material. For example, the sustain discharge electrode pairs may be formed of a conductive metallic material.

Driving of the transmitted type PDP 200 having the above structure may include driving for an address discharge and driving for a sustain discharge. The address discharge may occur between the address electrodes 223 disposed on the front substrate 220 and the Y electrodes 233 disposed on the rear substrate 230. As a result of the address discharge, wall charges may be formed on selected ones of the discharge cells 250. A sustain discharge may occur as a result of a potential difference between the X electrodes 232 and the Y electrodes 233 associated with the selected ones of the discharge cells 250 in which the wall charges may be formed. The phosphor layers 240 in the discharge space may be excited by UV light generated from the discharge gas during the sustain discharge, thereby emitting visible light. The visible light may transmit through the phosphor layers 240 and the front substrate 220, and may be emitted from the front substrate 220 so that an image(s) may be realized on the PDP 200.

In the PDP having the above structure, in addition to the existing phosphor layers, the EL layers that emit light simultaneously with the phosphor layers may be formed such that brightness of a PDP capable of displaying high definition images may be improved and high brightness may be obtained.

In embodiments of the invention, additional power is not required to drive the EL layers, and voltages employed for initiating sustain discharge operations and applied to the X electrodes and the Y electrodes may be simultaneously employed to create a voltage difference across two sides of the EL layers. Thus, embodiment of the invention need not employ additional power to increase brightness and/or improve a luminance distribution. That is, in embodiments of the invention, luminous efficiency of the PDP may be improved while employing a minimum amount of power necessary for initiating a sustain discharge in the discharge gas of the discharge cells of the PDP.

In embodiments of the invention, when sustain discharge occurs, current does not flow in the discharge cells that were not selected during the prior addressing operation. Thus, in such non-selected ones of the discharge cells, light may not emitted from the EL layers associated therewith.

In embodiments of the invention, a thickness of the phosphor layers formed on, e.g., a rear dielectric layer, may be larger than a thickness of a phosphor layer formed on side surfaces of the barrier ribs such that brightness of a PDP may be improved and discharge stability and luminous efficiency thereof may be improved.

Exemplary embodiments of the invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the invention as set forth in the following claims.

What is claimed is:

1. A plasma display panel, comprising:
a first substrate;
a second substrate opposing the first substrate;
a plurality of discharge cells defined between the first substrate and the second substrate;
a plurality of sustain discharge electrode pairs formed on the first substrate;
a dielectric layer covering the sustain discharge electrode pairs;
electroluminescent (EL) layers formed on the dielectric layer at least partially within the discharge cells;
a discharge gas disposed in the discharge cells; and
phosphor layers formed in the discharge cells.

2. The plasma display panel as claimed in claim 1, wherein the EL layers include at least one of inorganic EL material and quantum dots.

3. The plasma display panel as claimed in claim 2, wherein the EL layers emit light when a sustain voltage is applied between electrodes that form the sustain discharge electrode pairs.

4. The plasma display panel as claimed in claim 2, wherein the EL layers include at least one of ZnS:Mn, ZnS:Tb, SrS:Ce, Ca₂S₄:Ce, SrS:Cu, SrS:Ag, CaS:Pb, and BaAl₂:Eu.

5. The plasma display panel as claimed in claim 2, wherein a thickness of the EL layers is about 500 Å to about 5000 Å.

6. The plasma display panel as claimed in claim 2, wherein the quantum dots include a core formed of CdSe, a shell formed of ZnS and surrounding the core, and caps formed of trioctylphosphine oxide (TOPO) and disposed outside the shell.

7. The plasma display panel as claimed in claim 1, wherein the EL layers at least partially overlap with the sustain discharge electrodes.

8. The plasma display panel as claimed in claim 1, wherein the EL layers include a transparent material.

9. The plasma display panel as claimed in claim 1, wherein each of the discharge cells includes at least one of the EL layers arranged therein.

10. The plasma display panel as claimed in claim 1, wherein the EL layers correspond to each of the electrodes that form the sustain discharge electrode pairs and two EL layers are disposed in each of the discharge cells.

11. The plasma display panel as claimed in claim 10, wherein respective portions of the two EL layers associated with each of the discharge cells are substantially symmetrically arranged within the respective discharge cell.

12. The plasma display panel as claimed in claim 9, wherein each of the discharge cells includes two of the EL layers arranged therein, and each of the EL layers is only within one of the of the discharge cells.

13. The plasma display panel as claimed in claim 9, wherein the EL layers completely overlap with respective portions of the sustain discharge electrode pair of the respective discharge cell.

14. The plasma display panel as claimed in claim 1, further comprising:
address electrodes extending on the second substrate to cross the sustain discharge electrode pairs; and
a second dielectric layer covering the address electrodes.

15. The plasma display panel as claimed in claim 1, further comprising a protective layer on the EL layers and exposed portions of the dielectric layer where the EL layers are not formed.

16. The plasma display panel as claimed in claim 1, wherein the first substrate corresponds to a front substrate of the plasma display panel, the EL layers are arranged on the front substrate, and the EL layers are formed of a transparent material.

17. The plasma display panel as claimed in claim 1, wherein the first substrate corresponds to a rear substrate of the plasma display panel, the EL layers are arranged on the rear substrate.

18. A display panel, comprising:
a first substrate;
a second substrate;
a plurality of discharge cells defined between the first substrate and the second substrate;
a plurality of sustain discharge electrode pairs arranged on one of the first substrate and the second substrate;
a dielectric layer covering the plurality of sustain discharge electrode pairs;
first light emitting means for emitting light toward the first substrate; and
second light emitting means for emitting light toward the first substrate, wherein for each of the discharge cells:
the second light emitting means is arranged along a sustain discharge path of the plurality of sustain discharge electrode pairs, and
the first light emitting means and the second light emitting means substantially simultaneously emit light toward the first substrate based on a voltage potential across a corresponding one of the plurality of sustain discharge electrode pairs.

19. The display apparatus as claimed in claim 18, wherein the first light emitting means includes a discharge gas and at least one phosphor layer, and the second light emitting means includes an electroluminescent layer.
